(19) United States
(12) Patent Application Publication
(10) Pub. No.: US 2021/0241068 A1
(43) Pub. Date: Aug. 5, 2021

(54) CONVOLUTIONAL NEURAL NETWORK

(71) Applicant: HEWLETT PACKARD ENTERPRISE DEVELOPMENT LP, Houston, TX (US)

(72) Inventors: Martin FOLTIN, Ft. Collins, CO (US); John Paul STRACHAN, Milpitas, CA (US); Sergey SEREBRYAKOV, Milpitas, CA (US)

(73) Assignee: Hewlett Packard Enterprise Development LP, Houston, TX (US)

(21) Appl. No.: 17/049,032

(22) PCT Filed: Apr. 30, 2018
(86) PCT No.: PCT/US2018/030086

§ 371 Date: Oct. 20, 2020

(51) Int. Cl. G06N 3/04; G06N 3/10; G06N 3/08

(52) U.S. Cl. CPC G06N 3/04; G06N 3/08; G06N 3/10

(57) ABSTRACT

A convolutional neural network system includes a first part of the convolutional neural network comprising an initial processor configured to process an input data set and store a weight factor set in the first part of the convolutional neural network; and a second part of the convolutional neural network comprising a main computing system configured to process an export data set provided from the first part of the convolutional neural network.

### BACKGROUND

Artificial neural networks include computer systems that are modeled on the human brain and nervous system. Such networks may allow computers to learn from observational data and training sets, thereby allowing the computers to perform desired tasks in an efficient manner.

### BRIEF DESCRIPTION OF THE DRAWINGS

FIG. 1 shows a schematic representation of a computing system in accordance with one or more example embodiments.

FIG. 2 shows a schematic representation of a computing system including an input device in accordance with one or more example embodiments.

FIG. 3 shows a schematic representation of a computing system including multiple input devices in accordance with one or more example embodiments.

FIG. 4 shows a schematic representation of a computing system having divided first part processing in accordance with one or more example embodiments.

FIG. 5 shows a block diagram of a method for processing data i=using convolutional neural networks in accordance with one or more example embodiments.

FIG. 6 shows a block diagram of a method for optimizing convolutional neural networks in accordance with one or more example embodiments.

FIG. 7 shows a schematic representation of a general-purpose computing system that may be used in accordance with one or more example embodiments.

### DETAILED DESCRIPTION

One or more example embodiments are described in detail with reference to the accompanying figures. For consistency, like elements in the various figures are denoted by like reference numerals. In the following detailed description, specific details are set forth in order to provide a thorough understanding of the subject matter claimed below. In other instances, well-known features to one of ordinary skill in the art having the benefit of this disclosure are not described to avoid obscuring the description of the claimed subject matter.

Convolutional neural networks include computing paradigms for, among other things, image and video recognition, analytics of wave forms, human action analysis, malicious pattern detection in network security, sensor anomaly detection, network traffic, machine learning, and various other functions. Such networks may be used to process data that may output in one-dimension, two-dimension, or three-dimensions. Convolutional neural networks require large computing power in the order of several trillions of multiply and accumulate operations per second. Such networks are powerful tools in data processing, however, they are relatively expensive in an operation per Watt perspective. Accordingly, apparatuses, systems, and methods of decreasing the operation per Watt of convolutional neural networks may provide for more efficient processing of data sets through convolutional neural networks.

Various accelerators may be used to speed up neural network interference and training including graphics processing units, field-programmable gate arrays, single instruction multiple data computing, tensor processing units, and the like. Performance of such accelerators using convolutional neural networks may be hindered by scheduling overheads and the requirement to move data from on-die caches and off-die memory at high speeds. Embodiments of the present disclosure may thereby divide convolutional neural networks so that weight factors are stored in a first part of the network locally and thus do no need to be updated from cache or external memory between successive input data sets. The division of the weight factors and the local storage of such weight factor sets may thereby increase the processing speeds and/or decrease operational expenses for the computing process.

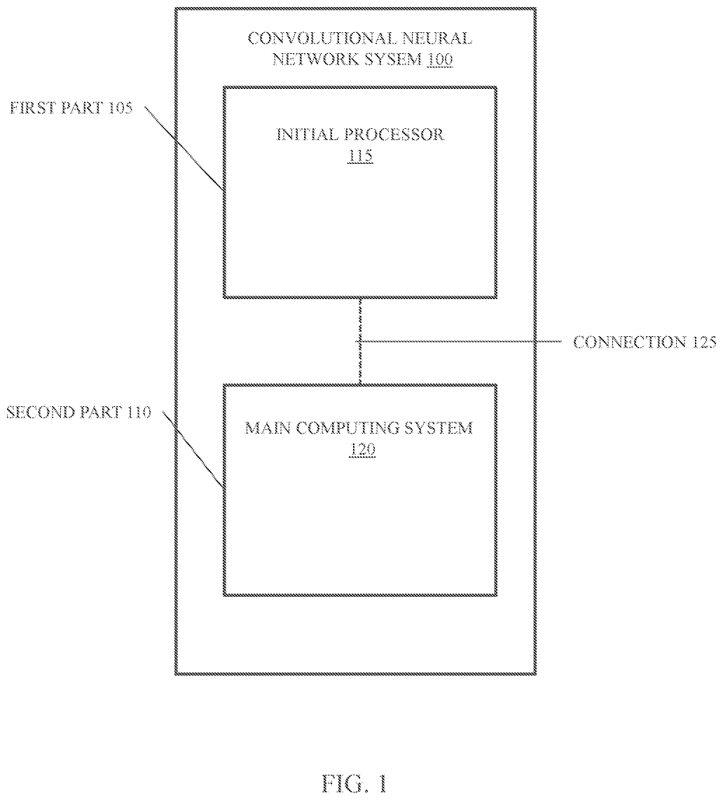

Turning to FIG. 1, a schematic representation of a computing system is shown. In this embodiment, a convolutional neural network system 100 is illustrated having a first part of the convolutional neural network 105 that has an initial processor 115. The convolutional neural network system 100 further includes a second part of the convolutional neural network 110 that includes a main computing system 120. The initial processor 115 is operationally connected to the main computing system 120 via connection 125, which will be discussed in detail below. The initial processor 115 may include various types of accelerators, while the main computing system 120 may include various types of central processing units, graphical processing units, accelerators, and the like.

In one embodiment, the initial processor 115 may include, for example, memory side accelerators on media, node controller application specific integrated circuits (“ASIC”), or other processors that are connected 125 to the main computing system 120 through memory fabric (not shown). In a second embodiment, the initial processor 115 may include, for example, an accelerator macro block integrated on a chip or ASICs that may be used in various Edge devices, for example, network access points/gateways, imaging devices, manufacturing control devices, etc. In the second embodiment, the initial processor 115 may be located on the same silicon as main computing system 120. In a third embodiment, the initial processor 115 may be located on Edge devices that are connected by wired or wireless local area networks to a data gateway, converged internet-of-things system access point, or a cloud datacenter. In such an embodiment, the gateway or datacenter contains the main computing system 120.

Convolutional neural networks include several convolutional layers and a small number of fully connected layers to extract desired features from an input data set and generate distribution over output class labels. An output from each network layer forms a feature map organized in d2 channels, where each channel attempts to extract certain raw features from d1 input channels from the previous layer. A combination of extracted features from the previous layer weighted in a manner learned during model training helps to identify a higher-level feature in the next layer. Repeating this over many layers enables the network to recognize complex features from the data set.

In each convolutional layer, the mapping is performed by convolving input feature maps with a filter that steps over the input field with a certain stride sx along the x dimension and sy along the y dimension. The filter size is relatively small along each channel dimension. In one example using image and video recognition, an input volume may be composed of 3 channels (RGB) of x*y pixel image fields, wherein the first layer filters may process receptive fields of xf*yf=7*7 pixels and map an input volume to 64 channels by stepping through input fields with stride sx=sy=2 pixels. In general, the number of weight factors in each layer is up to d1*xf*yf*d2 (if the filter operates on all d1 input channels), the data output size is (x−xf)*(y−yf)/((sx+1)*(sy+1))*d2 assuming no padding is performed on input data, and the number of multiply accumulate operations is approximately d1*xf*yf*(x−xf)*(y−yf)/((sx+1)*(sy+1))*d2, wherein these operations comprise the majority of the neural network computing time. Advancing through network depth from previous layers to the next layer, the input fields x and y are decreasing with layer number, and the number of channels d1 is increasing. However, the xf*yf receptive field is relatively constant or may decrease from 7*7 or 11*11 to 3*3 and 5*5. Thus, the number of computing operations per layer is generally decreasing and the number of weight factors is increasing with layer number.

Embodiments of the present disclosure divide the convolutional neural network system 100 into two parts 105 and 110, thereby allowing the processing of input data through the different parts 105 and 110 using a division of weight factors. The network system 100 is divided into the two parts 105 and 110 and each part 105 and 110 is mapped onto different hardware, wherein the first part 105 includes the first few network layers. Those of ordinary skill in the art having benefit of the present disclosure will appreciate that the number of layers mapped to the first part 105 may vary according to the requirements of a specific system 100. For example, in one embodiment one layer may be mapped to first part 105, while in another example, two, three, four, five or more layers may be mapped to first part 105. In certain embodiments, more than five layers, such as ten or more layers may be mapped to first part 105.

Accordingly, the main computing system 120 may be responsible for evaluation of the data in the second part 110 after processing in the first part 110. The second part 110 may thus include the classification layers of the computational neural network and may provide as output a classified data set according to the parameters of the network. By dividing the processing between first part 105 and second part 110, processing power required by the main computing system 120 may be decreased while efficiency is increased.

In order to determine an optimized division of the weight factors, i.e., the division point, the type of implementation as well as the available hardware is considered. For example, for cost sensitive Edge or memory side accelerator hardware, the division point may be selected so that the accelerator handles more than 50% of the computing effort but uses less than 10% of all weight factors. In such a system 100, the first part 105 of the computing may be performed by media controller ASICs or in Edge devices in computing blocks that are optimized to store the weight factors locally. In this system 100, the main computing system 120 will thus be responsible for less of the computing effort, thereby improving the computing performance of the system 100.

In another embodiment, when high performance memory side accelerator hardware or Edge devices are available, a different division point may be selected where the first part 105 handles more of the computing effort but uses fewer weight factors. For example, in such a system the first part 105 may use more than 50% of the weight factors but handle more than 90% of the computing effort.

Selection of an optimized division point may depend on various division point parameters including, for example, the amount of local storage available for weight factors, desired performance speed, desired performance speed increase, weight factor accuracy, and other such parameters known to those of ordinary skill in the art having benefit of the present disclosure.

Exemplary division points may include the first part 105 using 10%, 20%, 30%, 40%, 50%, 60%, 70%, 80%, or 90% of the weight factors with the second part 110 using the residual. In other embodiments, a division point may fall within a range, wherein the first part 105 uses 5-25%, 25-40%, 40-65%, 65-85% or 85-95% of the weight factors, with the second part 110 using the residual. By varying the division point, the computing power required by initial processor 115 and main computing system 120 may be optimized, thereby providing enhanced processing for system 100.

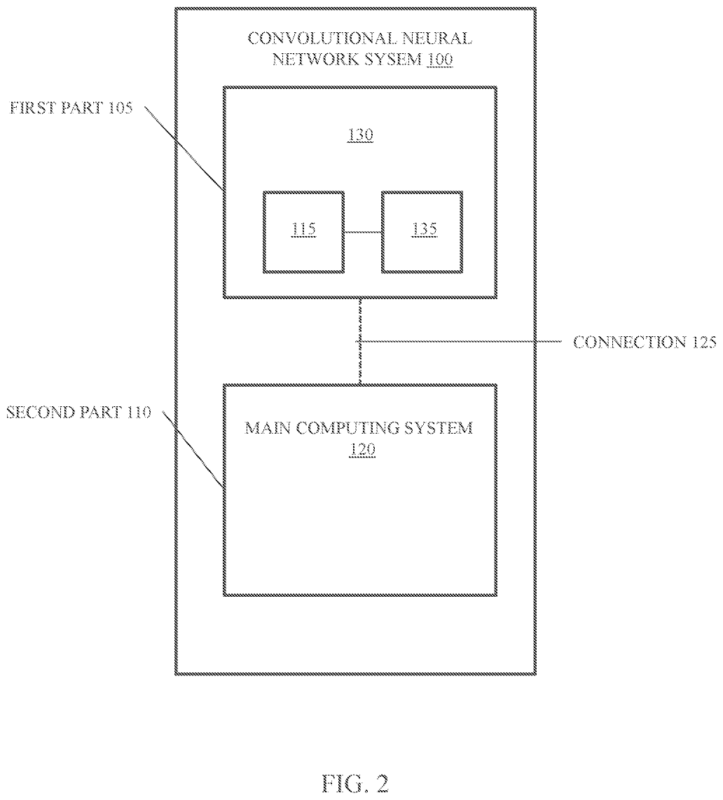

Referring to FIG. 2, a schematic representation of a computing system is shown. In this embodiment, the convolutional neural network system 100 includes a device 130 capable of capturing data that is connected to a main computing system 120. Examples of devices 130 may include cameras, phones, microphones, manufacturing automation systems, and other devices that capture data for processing. In this embodiment, the device 130 includes an initial processor 115, such as those described above with respect to FIG. 1. Device 130 also includes at least one memory 135 operationally connected to the initial processor 115. Examples of memory 135 may include, SDRAM, DDR, Rambus DRAM, ReRAM, or any other type of memory usable with devices and systems disclosed herein. Memory 135 is used to store weight factor sets locally on device 130, thereby giving initial processor 115 access to the weight factor sets without having to access other devices, external memory storage, or download externally stored data.

Device 130 is also operationally connected 125 to a main computing system 120. The main computing system 120 may include a work station that has general purpose computer processing or graphical processing units, as well as tensor processing unit or field programmable gate array accelerators. The connection 125 may be through a wired connection, such as Ethernet, or may be wireless.

During operation, the device 130 may gather data from an external source, for example, a picture may be taken in the form of raw image data. The raw image data may thus be transferred to the initial processing unit 115 that is located on or in close proximity to device 130. The raw image data may then be processed using the weight factor sets stored on memory 135 in order to produce a processed data set. The processed data set may then be output from device 130, which functions as the first part 105 of the system 100 to the second part 110, which includes the main computing system 120. The second part 110 then uses the second portion of the weight factor set and processes the processed output data to produce a final product.

In this embodiment, all of the first part 105 of system 100 is processed on device 130. Accordingly, the device 130 is responsible for the first several layers of processing, as described above. The division point between first part 105 and second part 110 may be divided as required by the hardware available in the single device 130 and/or the main computing system 120 and as discussed in detail above. In such an embodiment, it may be beneficial for first part 105 to process the first several layers, which are more computationally intensive, thereby decreasing the computing power of second part 110. Additionally, because first part 105 processes the computationally intensive portions, lessor bandwidth may be required to transfer the processed data from the first part 105 to the second part 110.

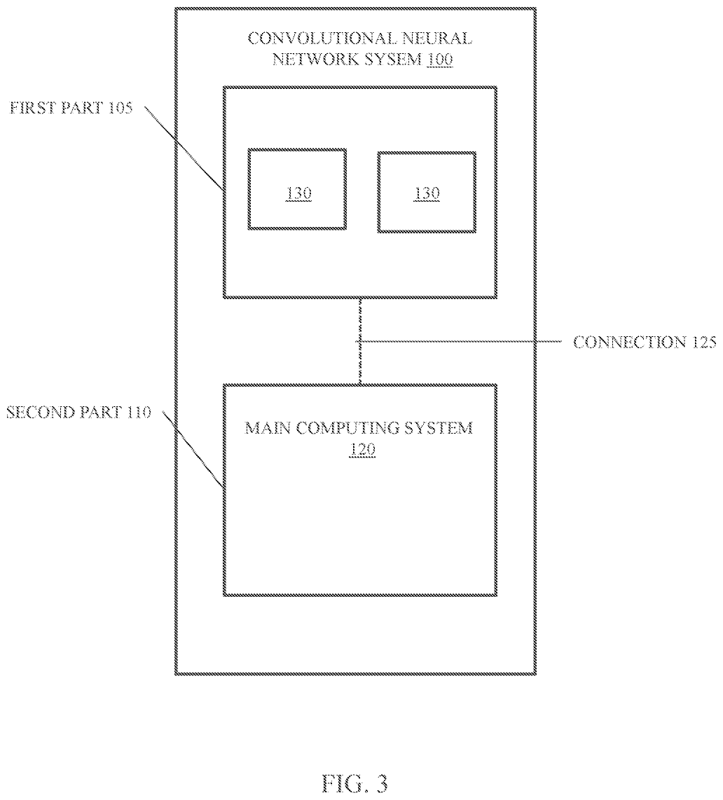

Referring to FIG. 3, a schematic representation of a computer system is shown. In this embodiment, the convolutional neural network system 100 includes a first part 105 and a second part 110. The first part 105 may include multiple devices 130, such as those described above with respect to FIG. 2. In this embodiment, data is captured by each device 130. Each device 130 includes an accelerator or other initial processor, 115 of FIGS. 1 and 2, that has access to locally stored weight factor sets, such as weight factor sets that may be stored on a memory, 135 of FIG. 2. As each device 130 is capturing data, the data may be processed individually by each device 130 to resolve the first several layers of the neural network, as described above. After the data is processed by the devices 130, the processed data from each device 130 may be transferred to main computing system 120 via connection 125. Thus, processed data from multiple devices 130 may be collectively processed by main computing system 120 in the second part 110 of the convolutional neural network.

An example of such a system 100 may include multiple cameras disposed around the periphery of a vehicle. Each camera may capture image data and process the first several layers of the data to form the first part 105 of the convolutional neural network. After the cameras process the first several layers, the processed data is sent individually or as a consolidated packet stream to the main computing system 120. Main computer system 120 may thereafter process the data to complete the second part 110 of the convolutional neural network, providing the processed data as output data.

Variations on the system 100 disclosed in FIG. 3 may include any of those discussed above with respect to FIGS. 1 and 2.

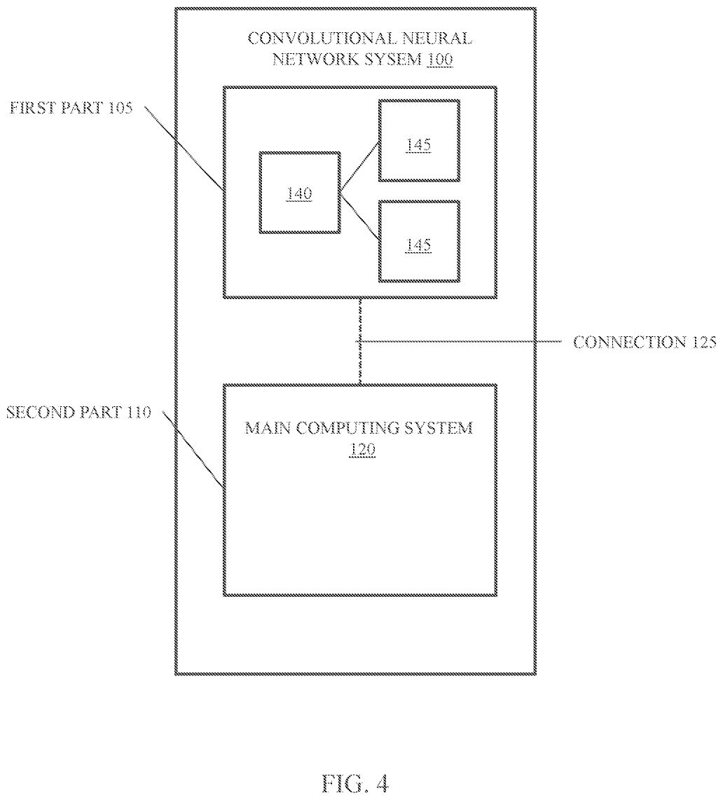

Referring to FIG. 4, a schematic representation of a computing system is shown. In this embodiment, the convolutional neural network system 100 includes first and second parts 105 and 110, wherein a data set is input initially into the first part 105. First part 105 may include a central processing unit 140 that, upon receiving the data set, disseminates the data to memory controllers 145, such as far side memory controllers. In this embodiment, two far side memory controllers 145 are illustrated. However, in other embodiments, one, three, four, or more than four far side memory controllers 145 may be used.

Each of the far side memory controllers 145 may include an accelerator, such as those discussed above, as well as memory, 135 of FIG. 2, that is used to store weight factor sets. The weight factor sets may be unique for each individual far side memory controller 145, or the sets may be substantially the same. Additionally, each far side memory controller 145 may have a unique memory for storing the weight factor sets or two or more far side memory controllers may share one or more memory modules. In such an embodiment, the memory modules may be located in situ with respect to the far side memory controllers 145 that will access the individual memory modules.

In this embodiment, input data may be sent to the first part 105 and processed by a central processing unit 140. As used herein, central processing unit 140 may include any type of processor, including any such processors described above. The processor then distributes the image data to the individual far side memory controllers 145. The far side memory controllers 145 may then process the image data using weight factor sets that are stored in memory accessible by the far side memory controllers 145. In such an embodiment, as with those discussed in detail above, the weight factor sets are stored in locally accessible memory modules, thereby allowing each far side memory controllers 145 to access the weight factor sets without having to access external data. In this embodiment the all of the input data may be provided to each of the far side memory controllers 145 in a batch form, thereby allowing each far side memory controller 145 to process the entire data set. The processed data may for each far side memory controller 145 may then be sent to the main computing system 120 to perform the final layers of the computation, thereby outputting a classification for each of the data sets provided by the far side memory controllers 145.

In certain embodiments, the input data may be divided into multiple data subsets, which may be referred to herein as cropping. One of the data subsets may be sent to a single far side memory controller 145, while other data subsets may be sent to other far side memory controllers 145. As such, the input data may effectively be divided amongst the far side memory controllers 145, so that each far side memory controller 145 is processing a different portion of the input data.

After the input data is processed by the far side memory controllers 145, the processed data is output to the main computer system 120 for the second part of the processing. In certain embodiments, the processed data is sent directly from the far side memory controllers 145 to the main computing system 120, while in other embodiments, the processed data is sent from the far side memory controllers 145 to an intermittent processor, such as the central processing unit 140. The data subset from each far side memory controller 145 may then be recombined and processed by the main computing system for the final layers of the convolutional neural network, thereby allowing the main computing system 120 to classify the data.

In a different embodiment, input data may be sent to the central processing unit 140, as discussed above. However, instead of dividing the input data into individual data subsets, the input data may be effectively cropped apart into subcomponents, also referred to as divided crops. Each subcomponent may then be sent to a different far side memory controller 145 for processing. An example of such an embodiment may include having a single image as the input data. The central processing unit 140 may then slice the image into multiple vertical and horizontally defined subcomponents, and each far side memory controller may be responsible for processing one of the subcomponents.

After the far side memory controllers 145 process each subcomponent, the subcomponents may be sent to the main computing system 120 and the main computing system 120 may classify each subcomponent individually. The main computing system 120 may retain the classification of each subcomponent individually or may later recombine the subcomponents into output data containing the classification data from each subcomponent as a single dataset, or in the example provided above, as a single classified image.

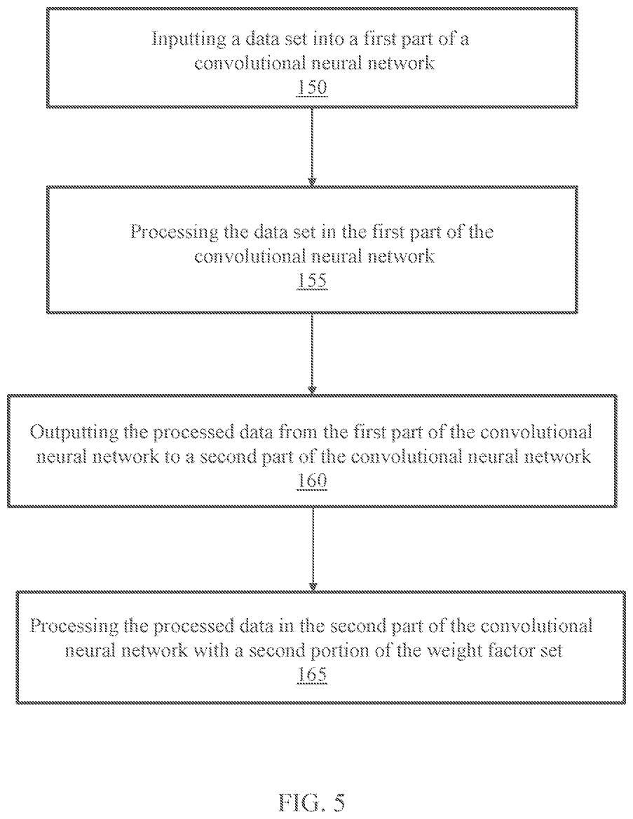

Referring to FIG. 5, a block diagram of a methods of processing data is shown. Embodiments of the present disclosure may allow data to be processed more efficiently by splitting weight factor sets between hardware portions of a convolutional neural network. Initially, the methods may include inputting a data set into a first part of a convolutional neural network (150). The first portion of a weight factor set is stored in the first part of the convolutional neural network. After inputting, the data set may be processed in the first part of the convolutional neural network using the first portion of the weight factor set (155).

After the processing (155), the processed data may be output from the first part of the convolutional neural network to a second part of the convolutional neural network (160). After outputting (160), the processed data may be reprocessed in the second part of the convolutional neural network with a second portion of the weight factor set (165). Accordingly, the first several layers are processed by the first part while the remainder is processed by the second part.

In certain embodiments, processing the data set in the first part of the convolutional neural network may include dispatching the data set to a plurality of modules disposed in the first part of the convolutional neural network. The dispatched data may be distributed to one or more accelerators having all or a portion of the weight factors stored thereon. Accordingly, the first part may one or multiple accelerators to process the data set.

In other embodiments, processing the data set in the first part of the convolutional neural network may include cropping the data set into a plurality of data sets and classifying each of the plurality of data sets. In this embodiment, the data sets may be cropped into multiple smaller input fields, thereby allowing each crop to be separately classified. Such embodiments may be useful where classified features of the data set occupy a large portion of the input field and individual crops would not contain sufficient information to provide a useful output.

In another embodiment, processing the data set in the first part of the convolutional neural network may include cropping the data set into a plurality of data sets, processing each of the plurality of data sets, and at least partially combining the processed plurality of data sets prior to outputting the processed data to the second party of the convolutional neural network. In this embodiment, the processed data from the multiple crops may be partially overlaid so that the full receptive field is included in the crop.

The method for processing data may further include defining a division point for the weight factor set, wherein the division point defines the number of weight factors in the first portion of the weight factor set and the number of weight factors in the second portion of the weight factor set. The division may use relative percentages to represent the number of weight factors in the first portion relative to the second portion or may use actual numbers.

As discussed in detail above, various permutations of relative weight factor division may be applicable, such as, for example, the first part of the convolutional neural network contains no more than 10 percent of the weight factors. In such an embodiment, the first part of the convolutional neural network may include at least 50% of the computing effort. In other embodiments, the division point divides the weight factor set to include 50% or less of the weight factors in the first part of the convolutional neural network. In this embodiment, the first part of the convolutional neural network may comprise at least 90% of the computing effort. Those of ordinary skill in the art having benefit of this disclosure will appreciate that various other divisions may be useful based on operational parameters of the system.

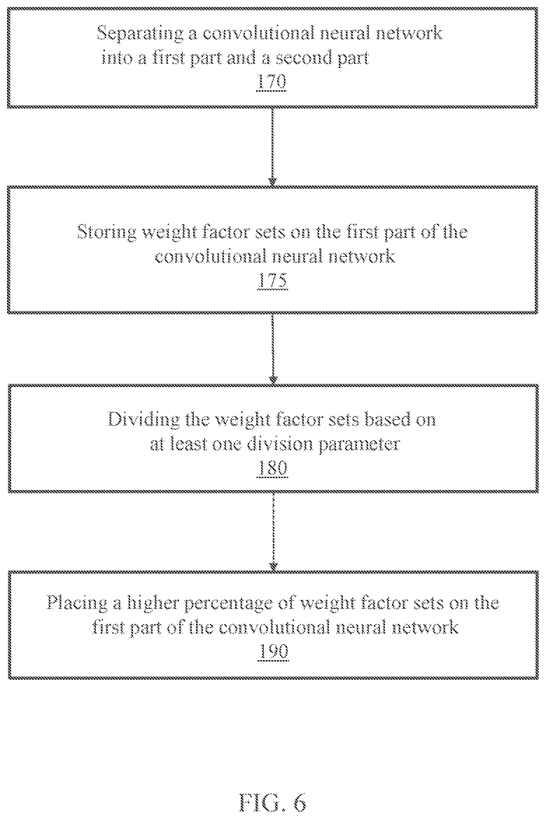

Referring to FIG. 6, a block diagram of a method of optimizing a convolutional neural network is shown. Optimizing convolutional neural networks generally refers to determining the requirements of the processing operation and adjusting parameters within the network in order to achieve the desired function within the limitations of the hardware being used. As described above with respect to the computing systems, in order to optimize a convolutional neural network, the network is separated into a first part and a second part (170). The first part of the network includes initial data processing and the second part of the network includes final data processing. As previously discussed, initial data processing may include running the first several layers of processing, while the final data processing may include classifying the final data into a desired data set.

After the network is separated, weight factor sets are stored on the first part of the convolutional neural network (175). For example, the weight factor sets may be stored on memory modules for specific devices or as part of memory modules on far side or other types of memory controllers. Because the weight factor sets are stored in situ, additional processing may be moved over to the first part of the network relative to the second part of the network.

The weight factor sets may be divided based on one or more division parameters (180). Examples of division parameters may include initial processing power, which refers to the processing power of one or more processors/accelerators in the first part of the network. Another division parameter may be a final processing power, which refers to the processing power of one or more processors in the main computing system. Other division parameters may include a number of layers within the network, a storage capacity of the memory module in the first part of the network, a number of weight factor sets, and a desired processing speed. Additionally, the division point may be determined by determining a ratio of maximum computing power available and processing speed desired. In such an embodiment, the maximum computer power available may be selected by determining one or more of an initial processing power, a final processing power, a number of layers, a storage capacity, a number of weight factor sets, or any other division parameter. The ratio may be completed by determining a processing speed desired by evaluating processing speed of the first part of the convolutional neural network, the processing speed of the second part of the convolutional neural network, a total system processing speed, and any other division parameter. This ratio may thus be adjusted to optimize computing power available in the convolutional neural network system based on a desired speed to achieve the efficiency desired. This same methodology may also be used to optimize the convolutional neural network system to optimize other desired end results such as, for example, computing power, processing speed, performance per Watt, processing time, or other application based desired end results.

In certain embodiments, a higher percentage of weight factor sets may be placed on the first part of the convolutional neural network relative to the second part (190). In one example, a system may include relatively low processing power in the first part of the network, while the second part of the network has relatively robust processing speeds. In such an embodiment, a relatively low number of weight factor sets may be moved to the first part of the network and stored thereon. For example, by moving 10% or less of the weight factor sets to the first part of the network, 50% or more of the computing effort may still be achieved by the first part of the network, while allowing the relatively robust second part of the network to handle more weight sets with decreased computing effort. Similarly, high processing power for the first part may allow more weight factors to be processed thereon, while decreasing the computing efforts of the second part of the network.

In a similar optimization a user may define a first threshold value for desired computing power and a second threshold value for weight factors so that the division point may be determined based on the relative improvements in system performance based on the ratio of the values. For example, a maximum threshold value for computing power may be selected based on hardware limitations or other division parameter limitations. This threshold may thereby represent the maximum available computer power available to the convolutional neural network. After the maximum computing power available is determined, a second value for minimum weight factors required may be selected. After the maximum threshold value for computing power and the minimum weight factors value is selected, a series of operations may be run on the convolutional neural network in order to determine whether moving more layers to the first part of the neural network is possible without decreasing computing performance. Similarly, moving more layers to the second part of the neural network may be tested to determine the optimum split of layers processed by both the first part of the neural network and the second part of the neural network. The division point may thus be determined by setting maximum and minimum values for computing power and weight factors, respectively, thereby improving overall computing performance for the convolutional neural network system.

The division of processing power may be adjusted based on a net desired speed, as well as the hardware limitations of the network. Other methods to optimize convolutional neural networks may be through the use of batch processing, crop processing, and divided crop processing, which is discussed in detail above. By modifying the physical components on the first or second part of the networks, one or more of the above listed processing techniques may be used to further enhance the operating efficiency of a convolutional neural network. For example, during batch processing or crop processing of a batch of image data or when the data is divided and processed individually, the first part of the convolutional neural network may be optimized by increasing storage capacity of memory and/or processing power of accelerators in order to process more of the computing intensive layers in the first part of the neural network. Accordingly, the processing power of the second part of the convolutional neural network may not have to be as robust, thereby improving the efficiency of the system.

In a second example, when divided crop processing is used, it may be beneficial to have more computing power in the second part of the convolutional neural network, thereby providing the overall system more computing power to reassemble and classify images in the main computing system. By varying the ratio of computing power in the first part of the convolutional neural network relative to the second part of the convolutional neural network may thereby optimize the system according to the requirements of the application.

In another embodiment, where there are memory and time constraints, a division point may be determined based on optimizing computing to find an optimal division point for different input data sizes. For example, a division point may vary depending on whether it is desirable to process one or a plurality of images at the same time. To optimize the first part of the computational neural network an algorithm may be provided that determines the time it takes to process data in the first part of the neural network, determines the memory required in the first part, defines the layers for computation in the first part and then processes multiple iterations. The layer flops, i.e., the number of floating point operations per section, may then be counted for each layer, the processing time may be determined for each layer, and the memory requirements for each layer may be computed. The amount of time and/or memory required may then be assessed to determine whether they meet the constrains of the application. This process may be computed for each subsequent layer, wherein the computation time and memory requirements for the first part of the neural network are updated and layers are subsequently added until there is a time or memory requirements violation. Accordingly, the maximum number of layers may be determined for an inputted data set based on memory and/or time requirements of the operation.

In certain applications, various computing systems and components thereof may be used to implement the apparatuses, systems, and methods disclosed herein. For completeness, an exemplary computing system with select components, which may be used with the embodiments discussed herein, is discussed in detail below.

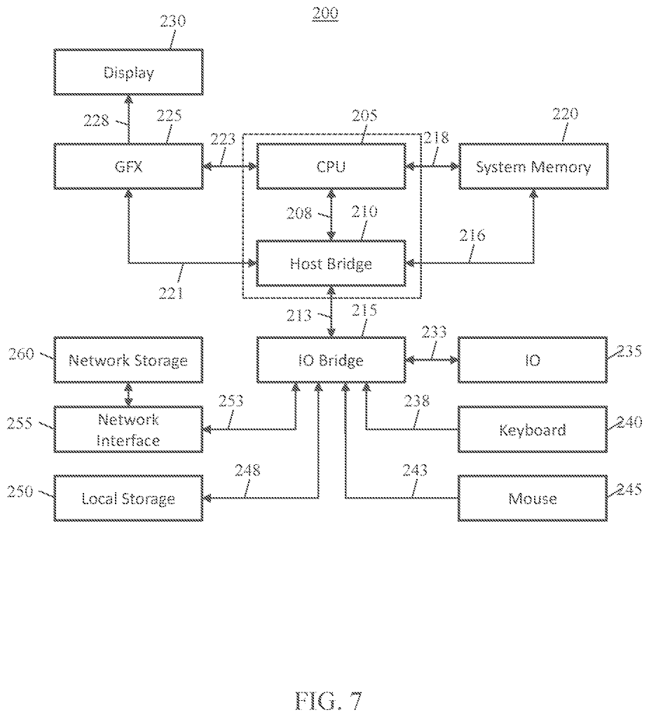

FIG. 7 shows a computing system 200 in accordance with one or more embodiments of the present invention. Computing system 200 may include one or more central processing units (singular “CPU” or plural “CPUs”) 205 disposed on one or more printed circuit boards (not otherwise shown). Each of the one or more CPUs 205 may be a single-core processor (not independently illustrated) or a multi-core processor (not independently illustrated). Multi-core processors typically include a plurality of processor cores (not shown) disposed on the same physical die (not shown) or a plurality of processor cores (not shown) disposed on multiple die (not shown) that are collectively disposed within the same mechanical package (not shown). Computing system 200 may include one or more core logic devices such as, for example, host bridge 210 and input/output (“IO”) bridge 215.

CPU 205 may include an interface 208 to host bridge 210, an interface 218 to system memory 220, and an interface 223 to one or more IO devices, such as, for example, graphics processing unit (“GFX”) 225. GFX 225 may include one or more graphics processor cores (not independently shown) and an interface 228 to display 230. In certain embodiments, CPU 205 may integrate the functionality of GFX 225 and interface directly (not shown) with display 230. Host bridge 210 may include an interface 208 to CPU 205, an interface 213 to IO bridge 215, for embodiments where CPU 205 does not include interface 218 to system memory 220, an interface 216 to system memory 220, and for embodiments where CPU 205 does not include integrated GFX 225 or interface 223 to GFX 225, an interface 221 to GFX 225. One of ordinary skill in the art will recognize that CPU 205 and host bridge 210 may be integrated, in whole or in part, to reduce chip count, motherboard footprint, thermal design power, and power consumption. IO bridge 215 may include an interface 213 to host bridge 210, one or more interfaces 233 to one or more IO expansion devices 235, an interface 238 to keyboard 240, an interface 243 to mouse 245, an interface 248 to one or more local storage devices 250, and an interface 253 to one or more network interface devices 255.

Each local storage device 250 may be a solid-state memory device, a solid-state memory device array, a hard disk drive, a hard disk drive array, or any other non-transitory computer readable medium. Each network interface device 255 may provide one or more network interfaces including, for example, Ethernet, Fibre Channel, WiMAX, Wi-Fi, Bluetooth, or any other network protocol suitable to facilitate networked communications. Computing system 200 may include one or more network-attached storage devices 260 in addition to, or instead of, one or more local storage devices 250. Network-attached storage device 260 may be a solid-state memory device, a solid-state memory device array, a hard disk drive, a hard disk drive array, or any other non-transitory computer readable medium. Network-attached storage device 260 may or may not be collocated with computing system 200 and may be accessible to computing system 200 via one or more network interfaces provided by one or more network interface devices 255.

One of ordinary skill in the art will recognize that computing system 200 may include one or more application specific integrated circuits (“ASICs”) that are configured to perform a certain function, such as, for example, hashing (not shown), in a more efficient manner. The one or more ASICs may interface directly with an interface of CPU 205, host bridge 210, or IO bridge 215. Alternatively, an application-specific computing system (not shown), sometimes referred to as mining systems, may be reduced to only those components necessary to perform the desired function, such as hashing via one or more hashing ASICs, to reduce chip count, motherboard footprint, thermal design power, and power consumption. As such, one of ordinary skill in the art will recognize that the one or more CPUs 205, host bridge 210, IO bridge 215, or ASICs or various subsets, supersets, or combinations of functions or features thereof, may be integrated, in whole or in part, or distributed among various devices in a way that may vary based on an application, design, or form factor in accordance with one or more embodiments of the present invention. As such, the description of computing system 200 is merely exemplary and not intended to limit the type, kind, or configuration of components that constitute a computing system suitable for performing computing operations, including, but not limited to, hashing functions. Additionally, one of ordinary skill in the art will recognize that computing system 200, an application specific computing system (not shown), or combination thereof, may be disposed in a standalone, desktop, server, or rack mountable form factor.

One of ordinary skill in the art will recognize that computing system 200 may be a cloud-based server, a server, a workstation, a desktop, a laptop, a netbook, a tablet, a smartphone, a mobile device, and/or any other type of computing system in accordance with one or more embodiments of the present invention.

When using neural networks, the networks are trained and validated through a number of steps or training processes. During training, a set of input/output patterns is repeated to the neural network. From this process, weights of the interconnections between the neurons is adjusted until the input yields a desired output. Training a neural network generally includes providing the neural network a training data set that includes known input variable and known output variables that correspond to the input variables. The neural network may then build a series of neural interconnects and weighted links between the input variables and the output variables. Using the training, the neural network may then predict output variables values based on a set of input variables.

To train an artificial neural network for a particular task, the training data set may include known input variables, such as image parameters, and known output variables, such as corresponding image parameters. After training, the neural network may be used to determine unknown corresponding image parameters by inputting raw image data. The raw image data may then be processed according to the methods described in detail above, thereafter outputting processed data about the image, corresponding image data, allegories, or other data derived by the neural network.

Those of ordinary skill in the art having benefit of the present disclosure will appreciate that there are various methods for training neural networks that may be used with embodiments disclosed herein. Accordingly, training neural networks may include the inputting of various data sets, experience information, data derived from prior simulations, and the like.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

While the present teachings have been described in conjunction with various examples, it is not intended that the present teachings be limited to such examples. The above-described examples may be implemented in any of numerous ways. For example, some examples may be implemented using hardware, software or a combination thereof. When any aspect of an example is implemented at least in part in software, the software code may be executed on any suitable processor or collection of processors, whether provided in a single computer or distributed among multiple computers.

Various examples described herein may be embodied at least in part as a non-transitory machine-readable storage medium (or multiple machine-readable storage media)—e.g., a computer memory, a floppy disc, compact disc, optical disc, magnetic tape, flash memory, circuit configuration in Field Programmable Gate Arrays or another semiconductor device, or another tangible computer storage medium or non-transitory medium) encoded with at least one machine-readable instructions that, when executed on at least one machine (e.g., a computer or another type of processor), cause at least one machine to perform methods that implement the various examples of the technology discussed herein. The computer readable medium or media may be transportable, such that the program or programs stored thereon may be loaded onto at least one computer or other processor to implement the various examples described herein.

The term “machine-readable instruction” are employed herein in a generic sense to refer to any type of machine code or set of machine-executable instructions that may be employed to cause a machine (e.g., a computer or another type of processor) to implement the various examples described herein. The machine-readable instructions may include, but not limited to, a software or a program. The machine may refer to a computer or another type of processor specifically designed to perform the described function(s). Additionally, when executed to perform the methods described herein, the machine-readable instructions need not reside on a single machine but may be distributed in a modular fashion amongst a number of different machines to implement the various examples described herein.

Machine-executable instructions may be in many forms, such as program modules, executed by at least one machine (e.g., a computer or another type of processor). Generally, program modules include routines, programs, objects, components, data structures, etc. that perform particular tasks or implement particular abstract data types. Typically, the operation of the program modules may be combined or distributed as desired in various examples.

Also, the technology described herein may be embodied as a method, of which at least one example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

Advantages of one or more example embodiments may include one or more of the following:

In one or more example embodiments, apparatuses, systems, and methods disclosed herein may be used to increase the performance per watt of convolutional neural networks.

In one or more example embodiments, apparatuses, systems, and methods disclosed herein may be used to more efficiently process data on convolutional neural networks.

In one or more example embodiments, apparatuses, systems, and methods disclosed herein may be used to decrease processing times on convolutional neural networks.

While the claimed subject matter has been described with respect to the above-noted embodiments, those skilled in the art, having the benefit of this disclosure, will recognize that other embodiments may be devised that are within the scope of claims below as illustrated by the example embodiments disclosed herein. Accordingly, the scope of the protection sought should be limited only by the appended claims.

What is claimed is:

1. A convolutional neural network system comprising:
a first part of the convolutional neural network comprising an initial processor configured to process an input data set and store a weight factor set in the first part of the convolutional neural network; and
a second part of the convolutional neural network comprising a main computing system configured to process an export data set provided from the first part of the convolutional neural network.

2. The convolutional neural network system of claim 1, wherein the initial processor is connected to the main computing system by a memory fabric.

3. The convolutional neural network system of claim 1, wherein the initial processor and the main computing system are disposed on the same silicon.

4. The convolutional neural network system of claim 1, wherein a division point is set to include 10 percent or less of the weight factor set in the first part of the convolutional neural network and provide at least 50 percent of a computing effort.

5. The convolutional neural network system of claim 1, wherein a division point is set to include 50 percent or less of the weight factor set in the first part of the convolutional neural network and provide at least 90 percent of a computing effort.

6. The convolutional neural network system of claim 1, wherein a division point is set to include 50 percent or less of the weight factor set in the first part of the convolutional neural network and provide at least 50 percent of a computing effort.

7. A method of processing data, the method comprising:
inputting a data set into a first part of a convolutional neural network, wherein a first portion of a weight factor set is stored in the first part of the convolutional neural network;
processing the data set in the first part of the convolutional neural network using the first portion of the weight factor set;
outputting the processed data from the first part of the convolutional neural network to a second part of the convolutional neural network; and
processing the processed data in the second part of the convolutional neural network with a second portion of the weight factor set.

8. The method of claim 7, wherein the processing the data set in the first part of the convolutional neural network comprises dispatching the data set to a plurality of modules disposed in the first part of the convolutional neural network.

9. The method of claim 7, wherein the processing the data set in the first part of the convolutional neural network comprises cropping the data set into a plurality of data sets and classifying each of the plurality of data sets.

10. The method of claim 7, wherein the processing the data set in the first part of the convolutional neural network comprises cropping the data set into a plurality of data sets, processing each of the plurality of data sets, and at least partially combining the processed plurality of data sets.

11. The method of claim 7, further comprising defining a division point for the weight factor set, wherein the division point defines the number of weight factors in the first portion of the weight factor set and the number of weight factors in the second portion of the weight factor set.

12. The method of claim 11, wherein the division point divides the weight factor set to include 10 percent or less of the weight factors in the first part of the convolutional neural network.

13. The method of claim 12, wherein processing the data set in the first part of the convolutional neural network comprises at least 50 percent of the computing effort.

14. The method of claim 11, wherein division point divides the weight factor set to include 50 percent or less of the weight factors in the first part of the convolutional neural network.

15. The method of claim 14, wherein processing the data set in the first part of the convolutional neural network comprises at least 90 percent of the computing effort.

16. A method of optimizing convolutional neural networks, the method comprising:
separating a convolutional neural network into a first part and a second part, wherein the first part comprises an initial data processing and the second part comprises a final data processing;
storing weight factor sets on the first part of the convolutional neural network; and
dividing the weight factor sets based on at least one division parameter.

17. The method of claim 16, wherein the dividing the weight factor sets based on at least one division parameter comprises determining a division point based on a ratio of maximum computing power available and processing speed.

18. The method of claim 17, wherein the maximum computer power available includes at least one of a determination of an initial processing power, a final processing power, a number of layers, and a storage capacity, and a number of weight factor sets, and the processing speed comprises a first part of the convolutional neural network processing speed, a second part of the computational neural network processing speed, and a total system processing speed.

19. The method of claim 16, further comprising placing a higher percentage of weight factor sets on the first part of the convolutional neural network relative to the second part of the convolutional neural network.

20. The method of claim 16, wherein the initial data processing comprises at least one of batch processing, crop processing, and divided crop processing.
